(19) United States
(12) Patent Application Publication
(10) Pub. No.: US 2026/0109324 A1
(43) Pub. Date: Apr. 23, 2026

(54) Technique for Signing Data with a Digital Vehicle Key

(71) Applicant: Bayerische Motoren Werke Aktiengesellschaft, Muenchen (DE)

(72) Inventor: Matthias FINK, Muenchen (DE)

(21) Appl. No.: 19/361,175

(22) Filed: Oct. 17, 2025

(30) Foreign Application Priority Data
Oct. 18, 2024 (DE) 10 2024 130 380.8

(51) Int. Cl. B60R 25/24; B60R 25/23

(52) U.S. Cl. CPC B60R 25/246; B60R 25/23

(57) ABSTRACT

A method for signing data with a digital vehicle key includes receiving an indication of a selected signature mode, wherein the signature mode is selected from at least one first signature mode and a second signature mode, wherein the at least one first signature mode concerns signing with the participation of a user, and the second signature mode concerns signing without the participation of the user; signing of data according to the selected signature mode; sending the signed data; and receiving a response regarding the signed data.

### CROSS REFERENCE TO RELATED APPLICATION

This application claims priority under 35 U.S.C. § 119 from German Patent Application No. DE 10 2024 130 380.8, filed Oct. 18, 2024, the entire disclosure of which is herein expressly incorporated by reference.

### BACKGROUND AND SUMMARY

The invention concerns a technique for signing data with a digital vehicle key. The technique is intended for implementation in a mobile device as well as in a backend on board a vehicle.

A motor vehicle can be secured by means of a concept specified as a “digital key” by the “Car Connectivity Consortium” (CCC). A comprehensive description can be found for example in the technical specification “Digital Key Release 4”. The concept provides for controlling a security function of the motor vehicle, for example a central locking system and/or an immobilizer, on the basis of an asymmetric cryptographic method. A user can be assigned a digital vehicle key in the form of a cryptographic data structure. A wireless connection between a mobile device and the motor vehicle is used for authentication on the basis of this key.

A digital vehicle key can contain, for example, a private part and a public part. The private part can be stored in a secured environment of a mobile device. Conversely, a digital key is assigned to the motor vehicle, the private part of which can be stored in a control device on board. A public part is known by a user. For controlling a security or access function, two-sided authentication is carried out on the basis of the respective private and public key components. If the authentication is successful, a requested security function on the vehicle is controlled, access to or use of the vehicle is made possible, etc.

A digital signature can be created with a digital vehicle key according to a CCC specification. Such a key can be provided, for example, in an exchange of messages. One example is the so-called standard transaction according to CCC for the establishment of a secure transmission channel, in which a review or verification of the respective counterparty is provided. Another example concerns an application for handling a digital vehicle key on a mobile device; such an application should be able to create a signature for different data on its own initiative.

According to the CCC standard, obtaining the user's consent is mandatory for the creation of such a signature, while authentication of the user can be optionally provided. Obtaining consent requires at least one output of a pop-up window on the mobile device, while authentication involves even more complex processes. However, such measures prolong and complicate an overarching process. However, depending on the data to be signed, it is inappropriate to impose such onerous methods on the user. For less security-critical data, however, the only option is to completely dispense with signature creation with verification, which is not a satisfactory solution from a security point of view.

One of the underlying objectives of the present invention is to provide an improved concept for a technique for signature creation and verification based on a digital vehicle key. The invention achieves this objective by means of the subject matter of the independent claims. Dependent claims reflect preferred embodiments.

A first aspect of the present invention concerns a method for signing data with a digital vehicle key. The method can be implemented on the user side, for example on a person's mobile device on which the digital vehicle key is stored, and preferably in an application for handling the digital vehicle key on the mobile device. The method involves receiving an indication of a selected signature mode. The signature mode is selected from at least one first signature mode and a second signature mode. The at least one first signature mode concerns signing with the participation of a user. The second signature mode concerns signing without the user's involvement. The method also includes initiating signing of data according to the selected signature mode; sending the signed data; and receiving response regarding the signed data, for example concerning a verification of the signed data.

A second aspect of the present invention concerns a method for verifying data signed with a digital vehicle key. The method can be implemented in a backend on board the vehicle, for example. The method involves sending an indication of a selected signature mode. The signature mode is selected from at least one first signature mode and a second signature mode. The at least one first signature mode concerns signing with the participation of a user. The second signature mode concerns signing without participation of the user. The method also includes receiving signed data; verifying the received signed data; and sending a response based on the verification of the signed data, for example a response regarding an action or operation that is performed based on the verified data.

In the case of some embodiments of the invention, the at least one first signature mode includes a signature mode concerning the consent or approval of the user and/or a signature mode concerning the authentication of the user. In order to obtain consent from the user, for example, a pop-up window can be output on a display of a mobile device, and the user gives their consent by making the pop-up window disappear, for example by tapping or clicking. Authentication can, for example, be carried out by means of a fingerprint sensor, facial recognition, entering a passphrase, etc. Obtaining consent and/or authentication from the user is time-consuming for the user, delays other processes, and reduces overall user comfort. According to the invention, it is proposed to waive the requirement to obtain consent or authentication for certain data, but without waiving the creation of a signature. The second signature mode proposed according to the invention does not require the user's participation and therefore enables a more convenient and faster verification.

Embodiments of the invention provide for several signature modes, at least one of which does not require the user's participation. In the case of one embodiment, “without participation” means a signature mode in which a signature is created without the user's consent and without the user's authentication (as is required by other signature modes). Such a signature mode can be provided, for example, if data or actions linked to the data are not significantly relevant to security, so that on the one hand it is not appropriate to carry out a consent and/or authentication procedure that is annoying and time-consuming for the user, but on the other hand secure processes should not be dispensed with. In the case of one embodiment, the signature mode according to the invention thus provides, in addition to the two signature modes regarding consent or authentication of the user, a further (third) specific combination or balance of security and user comfort.

In the case of certain embodiments of the invention, successful verification of the created signature is a prerequisite for the performance of an action, operation, functionality, function, sequence of a procedure, of a process, an activity, measure, etc., for example in a backend. Some embodiments can, for example, concern a signature creation for a simple or one-way data flow (as opposed to a message exchange, handshake, etc.), as well as an action based on the data flow, such as an assignment of a user account (based on a corresponding user ID) to a digital vehicle key.

In the case of some embodiments of the invention, the method according to the first aspect of the invention further includes passing the selected signature mode to a secured element; and receiving the data signed according to the selected signature mode from the secured element. This makes the creation of the signature particularly secure.

In the case of some embodiments, the data to be signed are also transferred to the secured element. The secured element signs the transferred data with the digital vehicle key stored in the secured element and transfers the data and signature, for example in a predefined data structure with several data fields, etc.

In the case of some embodiments, the selected signature mode is the second signature mode, and the secured element performs the signing without user participation. Here, for example, any output on a user interface can be omitted, or at least any output can be omitted that requires user participation, such as the output of a pop-up window, a window indicating that authentication has been performed, etc. This can provide a gain in convenience for the user when using the second signature mode, while at the same time a signature is generated in a secure manner.

In the case of some embodiments of the first aspect of the invention, signing without the user's participation is imperceptible to the user, i.e., from the user's point of view, the process takes place in a background, while another process takes place in a foreground, for example pairing of the mobile device and the motor vehicle by storing the digital vehicle key in the mobile device, key sharing or key transfer, etc., or there is no other process in the foreground, i.e. the mobile device appears inactive, passive, in a waiting state, etc.

In the case of some embodiments, an information field is provided for the transmission of the indication of the selected signature mode, namely at least two different predetermined values are provided for the indication of the respective signature mode. For example, at least one specific value may be provided for the indication of the first signature mode (with the participation of the user), and a different specific value is provided for the indication of the second signature mode (without user participation).

For example, the information field can be a data field of a SIGN command according to a CCC specification. The data field can be for example a tag 93h (or 0x93, i.e. in hexadecimal notation) with a length and a description or value, each of which describes a specific signature mode (from the at least one first signature mode and the second signature mode).

In the case of some embodiments of the second aspect of the invention, the backend decides on the signature mode to be applied. For example, for certain service requirements, authentication of the user may be mandatory. In other embodiments, the mobile device or an app on the mobile device can decide autonomously on the signature mode. With some of these embodiments, the method also includes receiving a request concerning the signing; verification of the received request; and selection of the signature mode from the at least one first signature mode and the second signature mode based on the verification. These embodiments provide flexibility in deciding which signature mode to be applied.

In the case of some embodiments of the second aspect of the invention, verifying the received signed data involves verifying a signature based on the digital vehicle key. In a backend, for example, there may be a public key portion of the digital vehicle key that can be used to carry out the verification.

In some of these or other embodiments, the verification of the received signed data may concern a verification of a user input or other user action taken regarding an action, operation, etc. The performed user's input or action does not have to directly concern an action to be performed. For example, a user-triggered storage of a digital vehicle key in the mobile device can be a trigger for an assignment, in the backend in the vehicle, of a user account to the assigned digital vehicle key.

In the case of certain embodiments, the method according to the second aspect of the invention, after successful verification, may include performing an action, operation, etc. The response based on the verification of the signed data can include a response regarding a (for example successful) performance of the action. The response can include an output via a user interface of the mobile device, for example an indication of the action taken, but which does not require any reaction from the user. In the case of other embodiments, such an output is dispensed with, i.e. the signature process and/or the action performed takes place completely in the background.

A further aspect of the present invention concerns a mobile device which is designed to sign data with a digital vehicle key using a method described herein. A “mobile device” is defined herein as a tablet or smartphone, a smartwatch, a smart band, a smart ring, etc., but generally any device on which a digital vehicle key, an assigned vehicle key (in the case of a “key sharing”) etc. can be stored, and which can be used to access a motor vehicle. This could also be a configuration of a mobile device with a smart card, or any other configuration or any other, even future device, which has the necessary processor capacities, storage capacities, etc.

In the case of one embodiment, the mobile device may contain a secured environment and/or a secured element for storing the digital vehicle key. In the case of some embodiments, the secured environment or element can be provided, for example by means of a cryptographic processor. In the case of some specific embodiments, for example in the case of the secured environment or the secured element, it can be for example an HSM (“Hardware Security Module”), TPM (“Trusted Platform Module”), a “Secure Enclave”, a TEE (“Trusted Performance Environment”) and/or a secured element in the sense of a “Secure Element”. For example, an electronic, cryptographic, or digital vehicle key, a derived vehicle key, a certificate, etc. can be stored in such a secured environment.

A software, an application (“App”), etc. may be installed on the mobile device, which implements device-side control of the signature process, including, if appropriate, interaction with the secured element. The app can, for example, be provided for handling the digital vehicle key in relation to a motor vehicle, for example by a manufacturer of the vehicle.

Yet another aspect of the present invention concerns a server, for example in a backend for the vehicle, which is designed to verify signed data with a digital vehicle key according to one of the methods described herein. The server can also be several servers, a server landscape, etc. The server(s) can, for example, be operated by a manufacturer of the vehicle. Server-side software, for example for operational and/or administrative key management, can implement methods according to the invention.

Yet another aspect of the present invention concerns a system comprising a motor vehicle designed to store a digital vehicle key. The system also comprises a mobile device designed to sign data with the digital vehicle key in accordance with a method described herein. The system also comprises a backend server designed to verify signed data with the digital vehicle key according to a method described herein.

The invention is now described in more detail with reference to the accompanying drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system;

FIG. 2A illustrates a flow chart of a first method;

FIG. 2B illustrates a flow chart of a second method; and

FIG. 3A and FIG. 3B collectively illustrate a flow chart of a third method.

### DETAILED DESCRIPTION OF THE DRAWINGS

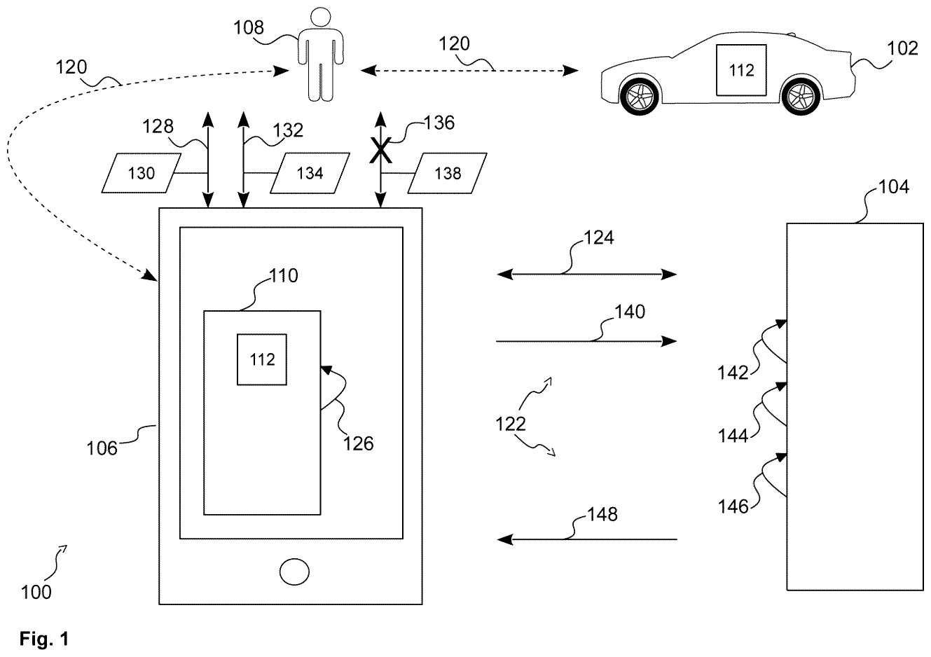

FIG. 1 shows in schematic form a system 100 with a motor vehicle 102, a server 104 in a backend for the vehicle 102, and a mobile device 106 of a user 108.

The reference sign “104” is used in the following both to generally designate a backend or the backend 104 (especially for the vehicle 102) and to specifically designate the server 104, wherein the server 104 can also be a plurality of interconnected servers.

The mobile device 106 has a secured element 110, which can be a “Secure Enclave”, a TEE, etc. In general, the secured element 110 can be provided by a cryptographic processor, for example.

A digital vehicle key 112 for the vehicle 102 is stored in the secured element 110. To be more precise, there is an end point in the secured element 110 (a data structure according to CCC) that represents the digital vehicle key 112 on the mobile device 106. In the vehicle 102 there is a corresponding end point, which represents the digital vehicle key 112 in the form in which it is stored in the vehicle 102. The details of the representation of the digital vehicle key 112 in the mobile device 106 on the one hand and in the vehicle 102 on the other are familiar to the person skilled in the art and are therefore not described further here.

It should be noted that a communication between a mobile device 106 and a backend 104 described below, for example can be based on one or more connections based on mobile communications and/or on short-range wireless connections, where for example the vehicle 102 can serve as a relay station for relaying communications between the mobile device 106 and the backend server 104. For reasons of clarity, this will not be discussed further in the further description.

The CCC standard provides that digital signatures can be created with a digital vehicle key (“digital signatures” are sometimes referred to as “signatures” herein). The creation, checking or verification of signatures can be provided for one-way or two-way message exchanges. For example, it can be envisaged that an application or app for handling the digital vehicle key 112 on the mobile device 106 creates a signature for arbitrary data.

A CCC specification provides a “SIGN” command for this purpose. To be more precise, data fields of the SIGN command are intended to indicate whether or not an authentication of the user 108 is required for a signature creation or not, or whether such authentication has been carried out or not, cf. the usage tag 93h or 0x93.

More specifically, the creation of a notification of the verification of the arbitrary data (“Data Attestation”) may require consent or approval of the user 108, while authentication of the user 108 is optional.

For example, if a signature creation is to be based on the consent of user 108, the user 108 will be presented with a pop-up window informing the user that the digital vehicle key 112 will be used to create a signature. The usage tag mentioned above would then indicate that user authentication has not been performed.

If a user authentication is to be carried out in which an explicit authentication of the user 108 is required, for example by entering a PIN (“Personal Identification Number”), a password, performing facial recognition, etc., the usage tag 93h indicates that a user authentication has been performed.

If only these two signature modes are available, performing a signature creation for arbitrary data always requires at least the output of a pop-up window on the mobile device 106 and appropriate user intervention (i.e., appropriate user participation 108). However, this type of signature creation may be inappropriate for the user 108 in certain cases, for example if it interrupts, prolongs, and/or complicates any other interaction between the user 108 and the mobile device 106. This can be the case, for example, during the performance of complex processes such as storage of the digital vehicle key 112 for the vehicle 102 in the mobile device 106, or key sharing or key transfer, etc.

One approach would be to dispense with the creation (and verification) of a signature altogether in such cases. However, this compromises security, i.e. a security concept would become incomplete.

According to the invention, it is proposed instead to supplement and extend the approach described above with the two modes “user consent” and “user authentication” by a third mode. This mode could be called “silent” or “silence”, or could be called “background mode” because it runs without the user's consent and without the user authentication required by the other two modes: in the background mode, a signature is created in the background from the user's point of view, i.e. without the need for user intervention as in the other modes, and is imperceptible to the user, i.e., without an output on a user interface of the mobile device 106 (or at least without an output to which the user would have to respond 108).

The proposed signature mode enables signature creation for use cases with low security risks, but while maintaining a level of security where the digital vehicle key 112 securely stored on the mobile device 106 is used for the signature creation, i.e. signature creation (and verification) does not have to be completely dispensed with.

For example, a typical use case that might require user authentication could be a purchase of an expensive item for the personal vehicle 102 of the user 108 in an app on the mobile device 106 (if that app is designed to handle the digital key 112). For example, a typical use case that could require user 108 consent might be a requirement for key transfer of the key 112.

A typical use case for which a signature creation proposed according to the invention could be provided “in the background”, i.e., without the user's participation, could be, for example, a binding or assignment of a vehicle-side or device-side account ID of the user 108 to the digital vehicle key 112. A process of such an assignment could take place in the backend 104 and could be triggered by other operations, such as creating a new user account, storing the digital vehicle key 112 on the mobile device 106, etc.

In the case of an exemplary embodiment of a security concept, further use cases for a signature creation according to the invention in the background could concern for example data that are not transmitted during a two-way message exchange, but in a one-way message flow, for example data that are transmitted to an on-board or device-side backend. However, other security concepts are also conceivable.

The backend server 104 may require a specific signature mode of two or three (or more) defined signature modes. Depending on how security-critical a use case is, how high a damage potential is, etc., the server 104 can, for example, require a signature mode that runs in the background, can require a signature mode with user consent, or can even require and specify a signature mode with user authentication. When verifying the created signature in the backend 104 (or for another instance), the signature mode specified for the creation is taken into account. This can prevent a compromised app on the mobile device 106 from creating a signature on its own and thus undermining the security concept.

In an exemplary embodiment based on a CCC specification, the usage tag (93h ) of a SIGN command must be able to represent all signature modes for backend-side implementation. For example, if the usage tag contains the value (length 4 bytes) D074DA4Fh, this can be an indication of a signature mode concerning a user authentication, and if the usage tag contains the value FC6F4C17h, this can be an indication of a signature mode of user consent. The (for example, third) signature mode proposed according to the invention for signing in the background should accordingly be assigned a given value XXXXXXXXh, wherein each “X” can individually adopt a value between 0 . . . F.

In a schematic exemplary embodiment, and again referring to FIG. 1, the user 108 interacts with the mobile device 106 in an operation 120 (which can include one or more user inputs), for example to perform an owner pairing, during which the digital vehicle key 112 for the vehicle 102 is stored in the mobile device 106. After successful completion of the operation 120, an account ID of the user 108 should be bound to the digital vehicle key 112 (as stored in the backend 104) in the backend 104. This additional process 122 has little security relevance but should not run completely unsecured. However, signature creation with user intervention would be inappropriate and confusing and disruptive for the user 108.

Therefore, the process 122 involves signature creation without user intervention, as described below. First, an app on the mobile device 106 requests a signature creation mode from the backend 104 in a request 124 and receives a signature mode specification from the backend 104, for example based on a predefined security concept with which specific security requirements are defined for specific data. In a process 126, the secured element 110 creates a signature according to the specified signature mode based on the digital vehicle key 112 stored there.

More specifically, the backend 104 can selectively specify one of three signature modes, and the secured element 110 implements this specification. A signature mode 128 requires consent of the user 108, for example clicking on a pop-up window on a display of the mobile device 106. An indication 130 (for example in the form of the usage tag described above or a comparable tag) of a correspondingly performed participation of the user 108 is sent to the mobile device 106, more precisely to the secured element 110, and only if the indication 126 is present, the secured element 110 creates the signature. A signature mode 132 requires authentication of the user 108, for example using a fingerprint sensor of the mobile device 106. Only when an indication or proof 134 of the completed participation of the user 108 (authentication) reaches the secured element 110 does the element 110 create the signature.

A (third, further, last) signature mode 136 does not require the participation of the user 108 as with modes 128, 132. If this signature mode 136 is specified, the secured element creates the required signature based on transferred data and the digital vehicle key 112 without waiting for an indication of user participation (such as the indication 130 or 134), because there is no such indication as indicated in FIG. 1, cf. reference sign 138. Rather, the signature process 122 runs in the background (if based on the signature mode 136), i.e. without the participation of and imperceptibly for the user 108.

In the further course of the process 122, the mobile device 106 (or the executing app) sends the signed data to the backend 104 in a transmission 140. Here, if appropriate, the signature creation is verified in a process 142, i.e. it is determined which signature mode was specified, and for the signature modes 128 or 132, it is necessary to check whether the respective participation of the user 108 on the device 106 has taken place. For the signature mode 136, such a check is omitted, as no participation is required.

In a process 144, the signature created by the secured element 110 is verified. If the check is successful, a requested action is carried out in a process 146, for example an assignment of an account ID to the digital vehicle key 112. In a process 148, the performance of the action and thus implicitly the successful verification of the signature and the signed data is confirmed.

Instead of the signature modes 128, 132 shown in FIG. 1, there could be further signature modes with the participation of the user 108. For example, several signature modes could each require a very specific form of authentication regarding user authentication, such as facial recognition, password entry, etc. Alternatively, there could be only one signature mode that requires user intervention, for example a response to a pop-up window, so that only two signature modes are available in total, a mode with user participation, and a mode without user participation.

Although the indications 130, 134 and 138 are shown in FIG. 1 for ease of understanding in association with user interventions 128 and 132 and the absence of user intervention 138 respectively, it is apparent to the person skilled in the art that these indications 130, 134, 138 could be represented as different values of the usage tag in a SIGN command, wherein the backend 104 selectively prescribes one of these values for signature creation.

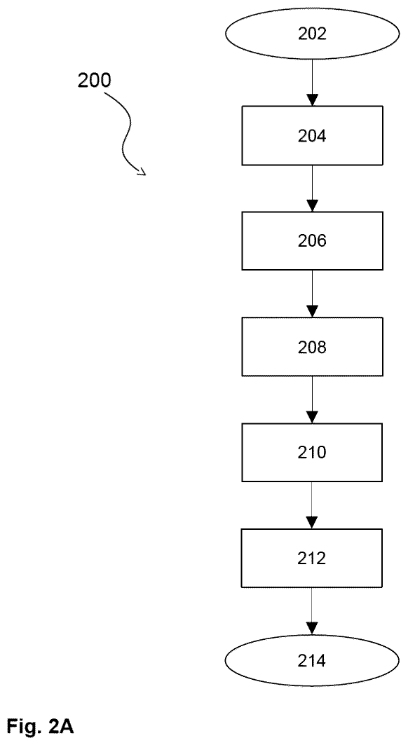

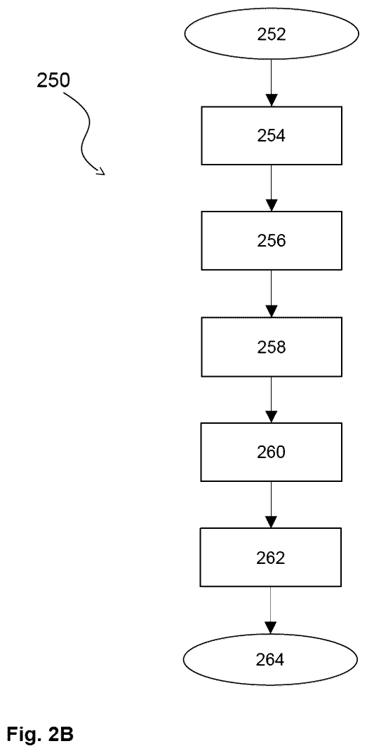

A specific exemplary embodiment of an interaction according to the invention of the mobile device 106 and the backend 104 for signature creation is described in more detail below with reference to the processes schematically shown in FIGS. 2A and 2B. FIG. 2A shows a sequence of a method 200 in the mobile device 106. FIG. 2B shows a sequence of a corresponding method 250 in the backend 104.

A sequence begins in the method 200 in FIG. 2A with an upstream step 202, in which an input from the user 108 is received. This can be done, for example. as described above for the operation 120 in FIG. 1. In step 204, the mobile device 106 sends a request for a signature mode to the backend 104. In a corresponding step 252 in the method 250 in FIG. 2B, the backend 104 receives the request. In a step 254, the backend 104 verifies the received request and based on this, selects the signature mode from the signature modes 128, 132, 136 in step 256.

In a step 258, the backend 104 sends an indication of the selected signature mode, for example of the signature mode 136, to the mobile device 106. In a corresponding step 206, the mobile device 106 receives the requested indication of the signature mode to be applied. In a step 208, the mobile device initiates the creation of a signature according to the signature mode selected by the backend 104 and specified in step 206. This can involve passing the specified signature mode to the secured element 110. In a step 210, the mobile device 106 or the app receives a signature from the secured element 110 and sends it to the backend 104 in a step 212.

In a corresponding step 260, the backend 104 receives the signature or the corresponding signed data. In a step 262, the backend 104 verifies the signature, and in a step 264 sends response regarding the signature and/or the success of an action performed based on the signed data to the mobile device 104 (see the description of process 144 in FIG. 1). In a corresponding step 214, the mobile device 106 receives the response.

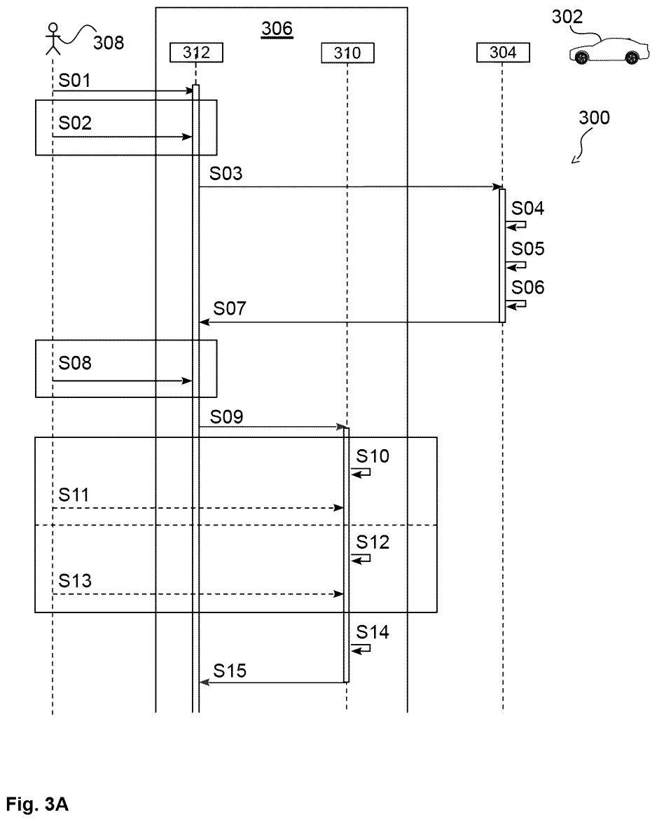

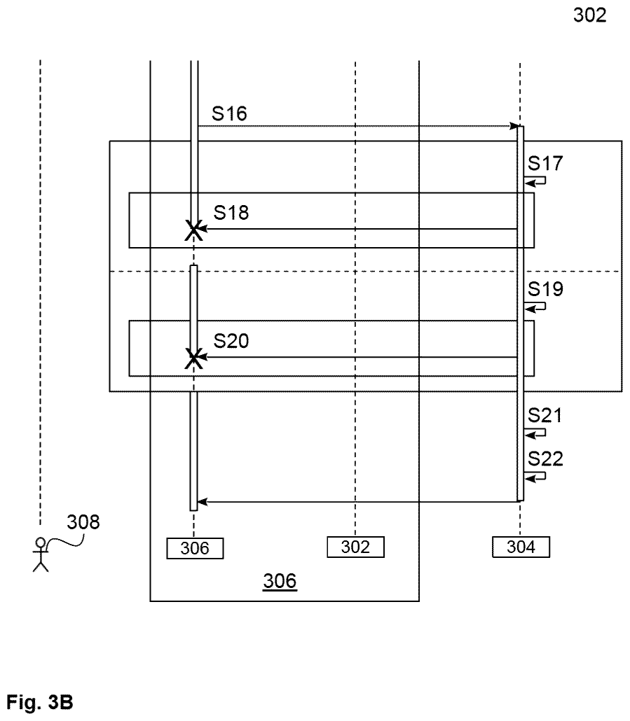

FIGS. 3A and 3B collectively illustrate in the form of a schematic sequence diagram a further exemplary embodiment of a method 300 according to the invention for signature creation. The method 300 could be a specific exemplary embodiment of the sequence 122 from FIG. 1, and in this respect reference is made to the description of FIG. 1 for an explanation of details such as definitions and terms used.

For the method 300, a backend 304 for a merely indicated vehicle 302 and a mobile device 306 of a user 308 work together. The mobile device 306 contains an instance of an operating system and/or a secured element 310, as well as an application or an app 312, which may be an app for handling a digital vehicle key for the vehicle 302, wherein the digital vehicle key is stored in the secured element 310. The app 312 can be provided by a manufacturer of the vehicle 302 and is therefore also referenced as a manufacturer app 312.

The method begins in a step S01 with the user 308 interacting with the app 312, for example to store the aforementioned digital vehicle key in the secured element 310 (“owner pairing”) or for key sharing. It should be explicitly noted that the signature creation method described below is not linked as such to the storage of a digital key generated in the owner pairing or key sharing. The interaction in step S01 is only to be understood as an example, namely in such a way that a digital key generated (for example) during owner pairing or key sharing is then linked to a user account of the user 308 by a signature (SIGN API). The step S01 can also comprise a number of steps. Optionally, a related user input can be made in step S02.

In a step S03, the app (or the “client”) 312 sends a request to the backend server 304 concerning a signature generation for a given use case, resulting from the action performed by the user 308 in step S01 and/or the user input in step S02. In a step S04, the backend 304 checks prerequisites for the given use case. In a step S05, the backend server 304 generates a session ID (for example a one-time piece of information).

In a step S06, the backend server 304 specifies the signature mode to be applied. As explained for the exemplary embodiment 100 of FIG. 1, there can be three signature modes, i.e. a signature mode that does not require the participation of the user 308, a mode that requires at least the consent of the user 308 as the participation of the user 308, and a signature mode that requires at least authentication as the participation of user the 308. In a step S07, the backend server 304 returns the session ID and the signature mode to be applied to the client app 312.

In an optional step S08, a (further) user input can be made (this can be related, for example, to the ongoing interaction of user the 308 with the mobile device 306, as described for step S01). In a step S09, the app 312 sends a request to create a signature for arbitrary data (“arbitrary data” according to the CCC specification) with the digital vehicle key for the vehicle 302 to the operating system/secured element 310. The request can include the signature mode to be applied as well as data to be signed. These data can for example include the session ID, data relating to the app 312 and/or data relating to the user inputs of steps S02 and S08.

If the signature mode to be applied (of the three signature modes described above) is the one that requires the user's consent as the participation of the user, the operating system/secured element 310 initiates the output of a pop-up window on a display of the mobile device 306 in a step S10. In a step S11, user 308 confirms acknowledgement of the pop-up window.

If, on the other hand, the signature mode to be used is the one that requires the user 308's authentication as his or her participation, the operating system/secured element 310 initiates the output of a user authentication window on the mobile device 306 in a step S12. In a step S13, the user 308 performs the required authentication by entering a PIN, a password, by facial recognition, etc.

If, on the other hand, the signature mode to be used is the one that does not require the participation of the user 308, a step such as one of steps S10 or S12 is omitted, i.e. no output is made on a user interface of the mobile device 306, but the operating system/secured element 310 immediately initiates the signature creation upon receipt of the corresponding request in step S09, and the user 308 does not receive any notice of the signature creation.

For the signature creation, in a step S14 the operating system/secured element 310 signs the data transferred in step S09 with the digital vehicle key stored in the secured element 310. The data are signed as “arbitrary data”. When the SIGN command is created, an indication of the signature mode used is specified as the value of the corresponding data field, the usage tag (0x93).

In a step S15, a data attestation of the data passed by the app 312 is returned to the app 312, as well as one-time information framework regarding the SIGN command. The data attestation contains required SIGN data fields, including the usage tag and the signature tag.

In a step S16, the app 312 sends a request for signature verification to the backend 304. The request contains the data attestation obtained from the secured element with one-time framework information, client data of the app 312, and optional data regarding the user inputs in the steps S02 and/or S08.

If the specified signature mode (of the three signature modes described above) is the one that requires the user 308 to be authenticated, in step S17 the backend server 304 checks whether a user authentication has been performed. If a different mode was applied, the server 304 returns an indication to the app 312 in a step S18 that the wrong signature mode was applied, and the method 300 is terminated.

If the specified signature mode requires the consent of the user 308 as the user's participation, the backend server 304 checks in a step S19 whether the user's consent has been obtained or whether an authentication of the user has carried out. If the check shows that the background signature mode has been applied, in a step S20 the server 304 returns an indication to the app 312 that the wrong signature mode has been applied and method 300 is terminated.

If, on the other hand, the specified signature mode does not require the user 308 to participate, there is no need for verification as in step S17 or S19 and the backend server 304 immediately initiates the verification of the signature received from the app 312 in step S16.

To verify the received signature, in a step S21 the server 304 compiles the “arbitrary data” that were subject to the signature creation in the secured element 310. Here the server can compile data from the obtained data attestation. The data can for example include an app ID of the app 312 that results from the context; app data such as the session ID (stored in the backend 304), received data of the client app 312, received data regarding the user inputs in steps S02 and/or S08; as well as the received one-time framework information. The signature can also be taken from the data attestation. As a key for the verification, the backend 304 can use a public key portion of the digital vehicle key for the vehicle 302.

If the verification is positive, the backend 304 performs an action in a step S22, which is to be secured with the signature creation or verification in the method 300. After the action has been performed, the backend 304 returns a note to the manufacturer app 312 in a step S23 that the signature has been recognized as valid, if appropriate that the requirements for user consent or authentication have been met, that the action has been successfully performed, etc.

According to the invention, methods for signature creation are proposed with which a signature is created based on a selection of a signature mode from several signature modes, and wherein at least one of the several signature modes does not require user participation, for example without the user's consent or authentication (as is the case with the other modes, for example). Such a signature mode can be provided, for example, for signing data that are not significantly security-related, i.e., to provide a way to maintain a certain level of security in such cases without bothering the user.

By providing this signature mode in addition to one, two, or more other signature modes with the participation of the user, embodiments of the invention make it possible to ensure an optimal balance between security and user comfort for different data. For example, the invention makes it practicable to include many less security-critical use cases in a security concept, in which protection has so far been dispensed with altogether because a request for user intervention (even if it is only with regard to obtaining consent or approval from the user) appeared unreasonably disruptive, time-consuming, complex, etc.

Embodiments of the invention can thus contribute to the development of incomplete security concepts with regard to improved security without this entailing disadvantages for user comfort. By enabling embodiments of the invention to improve a general level of security, they help to increase confidence in the practicability and security of digital vehicle keys, associated key management, etc., and this is of great importance in view of the increasing prevalence of digital vehicle keys.

Embodiments of the invention specifically suggest an extension of the SIGN command according to a CCC specification or a corresponding application programming interface (API). This extension can be inserted into existing systems with little effort, for example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
102 Vehicle
104 Backend
106 Mobile device
108 User
110 Secured element
112 Digital vehicle key
120 Pairing
122 Data transmission with signature generation and verification
124 Requesting a signature mode
126 Signature creation
128 Signature mode with user consent
130 Usage tag:
Indication of consent without authentication
132 Signature mode with user authentication
134 Usage Tag:
Indication of approval with authentication
136 Signature mode without user participation
138 Usage tag:
Indication of a mode without approval, without authentication
140 Data transmission to backend
142 User participation review
144 Signature verification
146 Implementation of action
148 Confirmation
200 Method
202 User input
204 Sending a request for a signature mode
206 Receiving an indication of a signature mode
208 Signature creation
210 Receiving the signature
212 Sending the signature
214 Receiving a response
250 Method
252 Receiving a request for a signature mode
254 Verifying the request
256 Selecting the signature mode
258 Sending an indication of a signature mode
260 Receiving the signature
262 Verifying the signature
264 Sending a response
300 Method
304 Backend
306 Mobile device
308 User
310 Operating system/secured element
312 App
S01-S07 Requesting a signature mode
S08-S15 Signing data
S16-S23 Verifying the signature

What is claimed is:

1. A method for signing data with a digital vehicle key, the method comprising steps of:
receiving an indication of a selected signature mode, wherein the signature mode is selected from at least one first signature mode and a second signature mode, wherein the at least one first signature mode concerns signing with the participation of a user, and the second signature mode concerns signing without the participation of the user;
initiating a signing of data according to the selected signature mode;
sending the signed data; and
receiving a response regarding the signed data.

2. The method as claimed in claim 1, wherein the at least one first signature mode comprises a signature mode which concerns the consent of the user and a further signature mode which concerns an authentication of the user.

3. The method of claim 1, further comprising:
passing the selected signature mode to a secured element; and
receiving a signature from the secured element according to the selected signature mode.

4. The method of claim 1, wherein the selected signature mode is the second signature mode, and the secured element performs the signing without the participation of the user.

5. The method of claim 1, wherein the signing without participation of the user is carried out imperceptibly to the user.

6. The method of claim 1, wherein for the indication of the selected signature mode, at least two different predetermined values are provided for transmission in an information field.

7. The method of claim 6, wherein the information field concerns a SIGN data field according to a specification of the Car Connectivity Consortium.

8. A method for verifying data signed with a digital vehicle key, the method comprising the steps of:
sending an indication of a selected signature mode, wherein the signature mode is selected from at least one first signature mode and a second signature mode, wherein the at least one first signature mode concerns signing with the participation of a user, and the second signature mode concerns signing without the participation of the user;
receiving signed data;
verifying the received signed data; and
sending a response based on the verification of the signed data.

9. The method of claim 8, wherein the method further comprises:
receiving a request concerning the signing;
verifying the received request; and
selecting the signature mode from the at least one first signature mode and the second signature mode based on the verification.

10. The method of claim 8, wherein the verification of the signed data includes verification of a signature based on the digital vehicle key.

11. The method of claim 8, wherein:
the verification concerns a verification of a user's input concerning an action, and the method further comprises:
performing the action after successful verification, wherein the response concerns the performance of the action.

12. A mobile device comprising one or more processors configured to sign data with a digital vehicle key by executing the method of claim 1.

13. The mobile device of claim 12, further comprising a secured element configured to store the digital vehicle key.

14. A backend server comprising one or more processors configured to verify signed data with a digital vehicle key by executing the method of claim 8.

15. A system, comprising:
a motor vehicle configured to store a digital vehicle key;
a mobile device comprising one or more processors configured to sign data with the digital vehicle key by executing a method comprising steps of:
receiving an indication of a selected signature mode, wherein the signature mode is selected from at least one first signature mode and a second signature mode,
wherein the at least one first signature mode concerns signing with the participation of a user, and the second signature mode concerns signing without the participation of the user;
initiating a signing of data according to the selected signature mode;
sending the signed data; and
receiving a response regarding the signed data; and
a backend server comprising one or more processors configured to verify data signed with the digital vehicle key by executing a method comprising steps of:
sending an indication of a selected signature mode, wherein the signature mode is selected from at least one first signature mode and the second signature mode;
receiving signed data;
verifying the received signed data; and
sending a response based on the verification of the signed data.
